(19) United States
(12) Patent Application Publication
(10) Pub. No.: US 2009/0172596 A1
(43) Pub. Date: Jul. 2, 2009

(54) DISPLAY CONTROL APPARATUS, DISPLAY CONTROL METHOD, AND PROGRAM

(75) Inventor: Yumi Yamashita, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/331,647

(22) Filed: Dec. 10, 2008

(30) Foreign Application Priority Data
Dec. 26, 2007 (JP) 2007-333563

(51) Int. Cl. G06F 3/048

(52) U.S. Cl. 715/834

(57) ABSTRACT

A display control apparatus controls display of a graphical user interface including a plurality of choices which are presented to a user and from which the user selects a choice. The display control apparatus includes a ring display generating unit configured to generate a ring display serving as the GUI, the ring display being formed by annually arranging a plurality of marks corresponding to the choices in a predetermined order; a marker adding unit configured to add a marker indicating at least one of the position of the first mark and the position of the last mark, among the plurality of marks arranged in the predetermined order, to the ring display; and a display controlling unit configured to display the ring display to which the marker is added.

### CROSS REFERENCES TO RELATED APPLICATIONS

The present invention contains subject matter related to Japanese Patent Application JP 2007-333563 filed in the Japanese Patent Office on Dec. 26, 2007, the entire contents of which are incorporated herein by reference.

### BACKGROUND OF THE INVENTION

1. Field of the Invention

The present invention relates to display control apparatuses, display control methods, and programs. More particularly, the present invention relates to a display control apparatus, a display control method, and a program that allow a user to efficiently and easily select a desired content item from multiple content items, such as programs.

2. Description of the Related Art

Systems are in widespread use in recent years, in which digital television signals are transmitted via satellites, such as broadcasting satellites and communication satellites, and are received by each home. Numerous programs are broadcast through 100 or more channels in the systems.

In order to allow a receiver side to select a desired program from the many programs without fail in such systems, the receiver side receives Electronic Program Guide (EPG) data that is transmitted to display the program guide (hereinafter referred to as the EPG) and selects the desired program from the EPG.

For example, Japanese Unexamined Patent Application Publication No. 2005-244867 discloses a program guide display apparatus displaying an EPG that is a spread sheet including multiple cells at intersections between date and time axes. The multiple cells are display areas where program information is displayed. The date axis is a horizontal axis along which multiple airdates and multiple days of week are indicated, and the time axis is a vertical axis along which airtimes are indicated at every two hours (particularly, refer to Paragraph [0126] and FIG. 4).

A user can use the above EPG to find a target program which the user wants to view or record.

However, since the EPG is targeted at a large number of programs, it is not possible to display all the programs at once in the EPG and to present the overall vision of the many programs that are broadcast.

Under such a situation, technologies for display of lists of all the numbers of channels on which the programs displayed in the EPG are broadcast are proposed.

In addition, technologies for display of disc-shaped lists in which favorite channel numbers are annularly arranged are proposed. In the display of the disc-shaped list, a user uses the EPG to set the numbers of channels on which favorite programs are broadcast as the favorite channel numbers.

### SUMMARY OF THE INVENTION

However, only the channel numbers are displayed with the technologies for display of the lists of all the numbers of channels or with the technologies for display of the disc-shaped lists. For example, when a user confirms the content of programs broadcast on the channels whose numbers are displayed to search for a desired program, it is necessary for the user to display the EPG.

In order to resolve the above problems, it is desirable to allow a user to efficiently and easily select a desired content item from multiple content items, such as TV programs.

According to an embodiment of the present invention, a display control apparatus controls display of a graphical user interface including a plurality of choices which are presented to a user and from which the user selects a choice. The display control apparatus includes ring display generating means for generating a ring display serving as the GUI, the ring display being formed by annually arranging a plurality of marks corresponding to the choices in a predetermined order; marker adding means for adding a marker indicating at least one of the position of the first mark and the position of the last mark, among the plurality of marks arranged in the predetermined order, to the ring display; and display controlling means for displaying the ring display to which the marker is added.

The display control apparatus may further include marking means for adding a mark specified by a specification operation by the user in the plurality of marks forming the ring display.

The display control apparatus may further include mark list generating means for generating a mark list that is a list of the marks added by the marking means. The display controlling means may display the mark list generated by the mark list generating means.

The mark list generating means may generate the mark list including detailed information about the choices corresponding to the marks added by the marking means.

The display controlling means may highlight a mark that is in focus in the plurality of marks forming the ring display.

According to another embodiment of the present invention, a display control method for a display control apparatus controlling display of a graphical user interface including a plurality of choices which are presented to a user and from which the user selects a choice includes the steps of generating a ring display serving as the GUI, the ring display being formed by annually arranging a plurality of marks corresponding to the choices in a predetermined order; adding a marker indicating at least one of the position of the first mark and the position of the last mark, among the plurality of marks arranged in the predetermined order, to the ring display; and displaying the ring display to which the marker is added.

According to another embodiment of the present invention, a computer-readable program for a display control apparatus controlling display of a graphical user interface including a plurality of choices which are presented to a user and from which the user selects a choice includes the steps of generating a ring display serving as the GUI, the ring display being formed by annually arranging a plurality of marks corresponding to the choices in a predetermined order; adding a marker indicating at least one of the position of the first mark and the position of the last mark, among the plurality of marks arranged in the predetermined order, to the ring display; and displaying the ring display to which the marker is added.

According to the embodiments of the present invention, the ring display is generated which serves as the GUI and which is formed by annually arranging the plurality of marks corresponding to the choices in a predetermined order. The marker indicating at least one of the position of the first mark and the position of the last mark, among the plurality of marks arranged in the predetermined order, is added to the ring display and the ring display to which the marker is added is displayed.

According to the present invention, it is possible to allow a user to efficiently and easily select a desired content item from multiple content items, such as TV programs.

### BRIEF DESCRIPTION OF THE DRAWINGS

FIG. 1 is a block diagram showing an example of the configuration of a digital television (DTV) according to an embodiment of the present invention;

FIG. 2 is a block diagram showing an example of the functional blocks realized by a CPU in FIG. 1 that executes certain programs;

FIG. 3 shows an example of a screen including a ring display;

FIG. 4 shows an example of a screen including the ring display to which favorite marks are added;

FIG. 5 shows an example of a screen including the ring display to which the favorite marks are added and a channel display list; and

FIG. 6 is a flowchart showing an example of a display process according to an embodiment of the present invention.

### DESCRIPTION OF THE PREFERRED EMBODIMENTS

Embodiments of the present invention will herein be described with reference to the attached drawings.

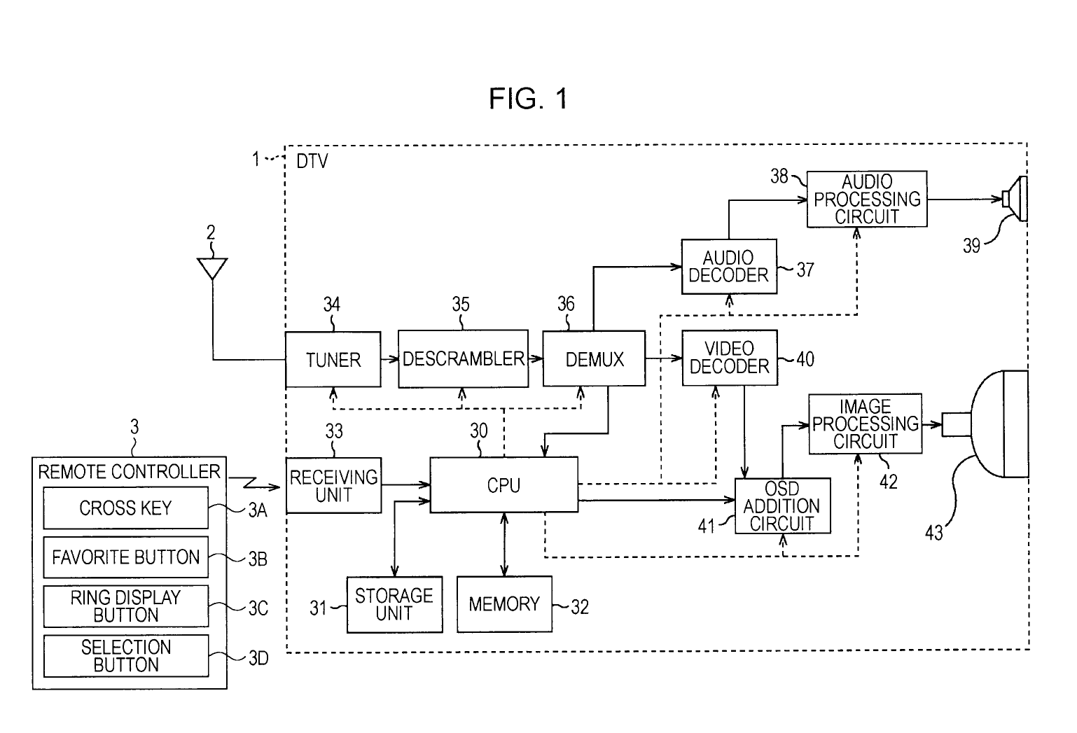

FIG. 1 is a block diagram showing an example of the configuration of a digital television (DTV) according to an embodiment of the present invention.

Referring to FIG. 1, a DTV 1 receives a television (TV) program in response to an operation signal transmitted from a remote controller 3 to display the received TV program.

The DTV 1 includes a central processing unit (CPU) 30, a storage unit 31, a memory 32, a receiving unit 33, a tuner 34, a descrambler 35, a demultiplexer (DEMUX) 36, an audio decoder 37, an audio processing circuit 38, a speaker 39, a video decoder 40, a On-Screen Display (OSD) addition circuit 41, an image processing circuit 42, and a display 43.

The remote controller 3 transmits an operation signal corresponding to a key operation by a user.

In the DTV 1, the CPU 30 executes programs stored in the storage unit 31 to perform a variety of processing. For example, the CPU 30 controls the tuner 34, the descrambler 35, the DEMUX 36, the audio decoder 37, the audio processing circuit 38, the video decoder 40, the OSD addition circuit 41, and the image processing circuit 42 in response to the operation signal that is transmitted from the remote controller 3 operated by the user and is received by the receiving unit 33 to display the image of the TV program in the display 43 and to output the audio of the TV program from the speaker 39.

The CPU 30 supplies EPG data from the DEMUX 36 to the memory 32 and stores the EPG data in the memory 32. The EPG data includes detailed information about programs that are broadcast, such as the titles of the programs, the genres thereof, the performers thereof, the outlines thereof, and the snapshots thereof, the numbers of the channels on which the programs are broadcast, and a variety of information including the logos of the broadcast stations on which the programs are broadcast.

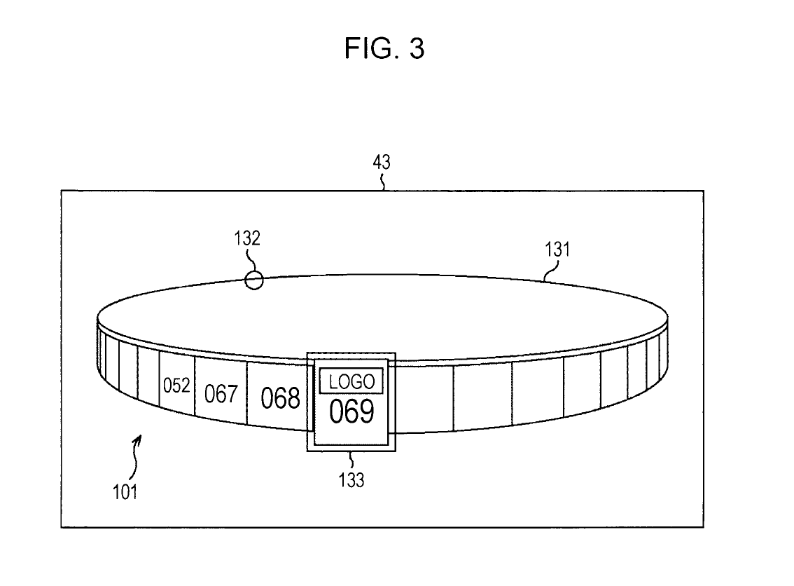

The CPU 30 reads out the EPG data stored in the memory 32 to generate a ring display 101 (FIG. 3) that is synthesized with (superimposed on) the image of the program and is displayed in the display 43 and/or image data representing the EPG on the basis of the EPG data and supplies the ring display 101 and/or the image data to the OSD addition circuit 41.

The storage unit 31 is a so-called non-volatile storage medium on which data can be rewritten and which is capable of holding the content of recorded data even when the DTV 1 is turned off. The storage unit 31 is, for example, a hard disk, a flash memory, an electrically erasable programmable read only memory (EEPROM), a magnetoresistive random access memory (MRAM), or a ferroelectric random access memory (FeRAM). The storage unit 31 stores the programs and data used by the CPU 30 to perform the variety of processing. The programs and data stored in the storage unit 31 can be rewritten to be updated.

The programs executed by the CPU 30 may be installed in the storage unit 31 via a transmission medium, such as TV broadcasting or the Internet, or from a certain recording medium, instead of being stored in the storage unit 31 in advance.

The receiving unit 33 receives the operation signal, which is transmitted from the remote controller 3 in response to a key operation by the user, and supplies the received operation signal to the CPU 30.

The tuner 34 receives and demodulates a TV broadcast signal via an antenna 2 or a cable television (CATV) line and supplies a transport stream resulting from the demodulation to the descrambler 35. The transport stream includes the EPG data, in addition to video data and audio data about the program.

The descrambler 35 descrambles the transport stream supplied from the tuner 34 and supplies the transport stream resulting from the descrambling to the DEMUX 36.

The DEMUX 36 extracts a component corresponding to the channel selected by the user from the transport stream supplied from the descrambler 35 and separates the extracted component into the audio data, the video data, and the EPG data. The DEMUX 36 supplies the audio data to the audio decoder 37, supplies the video data to the video decoder 40, and supplies the EPG data to the CPU 30.

The audio decoder 37 decodes the audio data supplied from the DEMUX 36 and supplies the audio data resulting from the decoding to the audio processing circuit 38.

The audio processing circuit 38 performs digital-to-analog (D/A) conversion, amplification, etc. to the decoded audio data supplied from the audio decoder 37 and supplies the resulting audio data to the speaker 39 from which the corresponding audio is output.

The video decoder 40 decodes the video data supplied from the DEMUX 36 and supplies the video data resulting from the decoding to the OSD addition circuit 41.

When the image data representing the ring display, the EPG, or the like is supplied from the CPU 30, the OSD addition circuit 41 synthesizes the decoded video data, which is supplied from the video decoder 40 and which represents a certain program, with the image data supplied from the CPU 30 and supplies the resulting synthesized data to the image processing circuit 42.

When the image data is not supplied from the CPU 30, the OSD addition circuit 41 directly supplies the decoded video data supplied from the video decoder 40 to the image processing circuit 42 as the synthesized data.

The image processing circuit 42 performs certain image processing, the D/A conversion, etc. to the synthesized data supplied from the OSD addition circuit 41 and supplies the resulting synthesized data to the display 43.

The display 43 displays the image corresponding to the synthesized data supplied from the image processing circuit 42. For example, the display 43 displays the image of the program, the image resulting from the synthesis of the ring display 101 with the image of the program, or the image resulting from the synthesis of the EPG and the ring display with the image of the program.

The remote controller 3 has operation keys including a cross key 3A, a favorite button 3B, a ring display button 3C, and a selection button 3D, in addition to general keys including a volume key used to control the volume and a numeric keypad used to select a channel (not shown). The cross key 3A is capable of being operated upward, downward, leftward, and rightward. The cross key 3A is used by the user to operate, for example, the ring display 101 (FIG. 3) serving as a graphical user interface (GUI) that presents multiple channels to the user as choices which the user can select. The favorite button 3B is used by the user to specify a favorite channel. The ring display button 3C is used by user to display the ring display 101. The selection button 3D is used by the user to select a choice (channel).

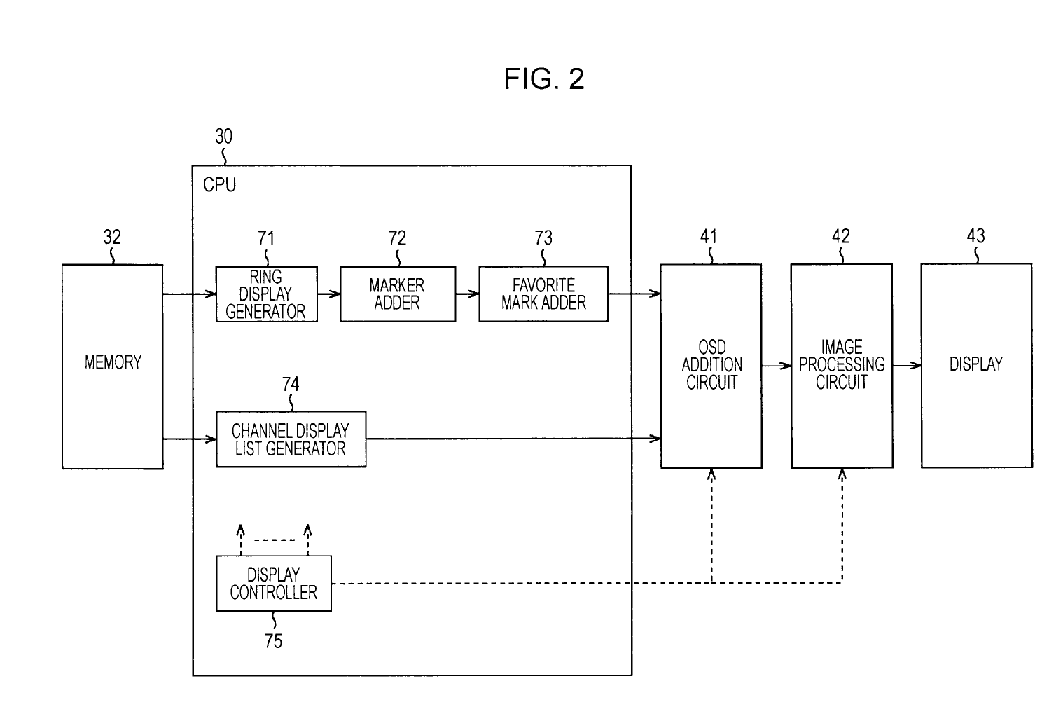

FIG. 2 is a block diagram showing an example of the functional blocks realized by the CPU 30 in FIG. 1 that executes the programs stored in the storage unit 31.

The CPU 30 includes a ring display generator 71, a marker adder 72, a favorite mark adder 73, a channel display list generator 74, and a display controller 75 as the functional blocks.

The ring display generator 71 generates the ring display on the basis of the channel numbers and the logos of the broadcast stations included in the EPG data stored in the memory 32, and supplies the ring display to the marker adder 72. The ring display is formed by annularly arranging multiple channel marks on which the channel numbers and the logos of the broadcast stations are displayed in a predetermined order, for example, in an order recommended by Association of Radio Industries and Businesses (ARIB).

The marker adder 72 adds a marker 132 (FIG. 3) indicating a predetermined position on the ring display to the ring display supplied from the ring display generator 71.

The predetermined position indicates at least one of the position of the first channel mark and the position of the last channel mark, among the multiple channel marks annularly arranged in the predetermined order.

Accordingly, the marker 132 is added on the first channel mark when the marker 132 indicates the position of the first channel mark, is added on the last channel mark when the marker 132 indicates the position of the last channel mark, or is added between the first channel mark and the last channel mark when the marker 132 indicates the positions of both the first channel mark and the last channel mark.

It is assumed in the present embodiment for simplicity that the marker 132 indicates the positions of both the first channel mark and the last channel mark and is added between the first channel mark and the last channel mark.

The marker adder 72 supplies the ring display to which the marker is added to the favorite mark adder 73.

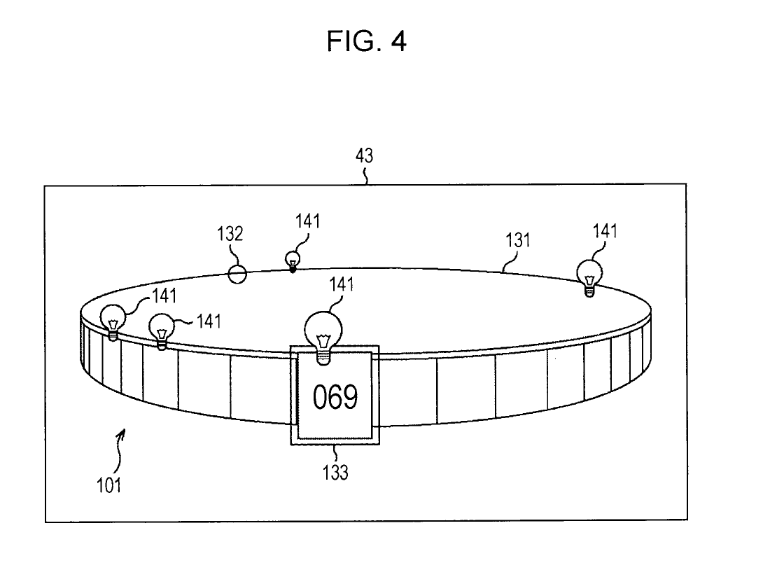

If the channel mark is present for which addition of a favorite mark (marking) is specified by a specification operation by the user with the favorite button 3B, the favorite mark adder 73 performs the marking to add favorite marks 141 (FIG. 4) to the channel marks specified by the specification operations by the user, among the multiple channel marks, and supplies the ring display resulting from the marking to the OSD addition circuit 41 (FIG. 1).

If the channel mark specified by the specification operation by the user with the favorite button 3B is not present, the favorite mark adder 73 directly supplies the ring display from the marker adder 72 to the OSD addition circuit 41.

If the channel mark specified by the specification operation by the user with the favorite button 3B is present, the channel display list generator 74 generates a channel display list (mark list) on the basis of the channel numbers, the logos of the broadcast stations, and the detailed information about the programs, which are included in the EPG data stored in the memory 32, and supplies the channel display list to the OSD addition circuit 41. The channel display list is a list of the channel marks specified by the specification operations by the user and the detailed information about the channels corresponding to the channel marks (the detailed information about the programs broadcast on the channels corresponding to the channel numbers of the channel marks).

The display controller 75 controls the OSD addition circuit 41 and the image processing circuit 42 to display the ring display output from the favorite mark adder 73 and the channel display list output from the channel display list generator 74 in the display 43.

FIG. 3 shows an example of a screen that is displayed in the display 43 and that includes a ring display to which a marker is added.

A bird's-eye view of the ring display 101 having a column shape (disc shape) from a direction in which an elliptical area surrounded by a closed curve 131 is looked down at an angle is displayed in the display screen in FIG. 3. The ring display 101 has a side face including multiple channel marks annularly arranged in a predetermined order and has a bottom surface that is the elliptical area surrounded by the closed curve 131 formed by the multiple channel marks.

In other words, the closed curve 131 to which the marker 132 is added and the channel marks represented by multiple rectangles horizontally arranged in a band shape on part of the closed curve 131 compose the ring display 101 in the display screen in FIG. 3.

The central channel mark surrounded by a frame 133 indicates the channel mark that is in focus and is highlighted, compared with the other channel marks.

Specifically, the channel mark (hereinafter referred to as the channel mark “069”) on which a channel number “069” and a logo “LOGO” of the broadcast station having the channel number “069” are indicated is displayed as the channel mark that is in focus on a largest scale, compared with the other channel marks (for example, a channel mark “068”). In addition, the frame 133 surrounding the channel mark “069” is highlighted in a color and/or size different from those of the frames surrounding the other channel marks.

The lengths of the channel marks along the closed curve 131 are decreased as the channel marks are away from the channel mark “069” that is in focus.

Specifically, in the display screen in FIG. 3, the channel mark “0681”, the channel mark “0671”, and the channel mark “0521” are sequentially arranged on the left side of the channel mark “0691” that is in focus. Accordingly, the channel mark “069” that is in focus, the channel mark “068”, the channel mark “067”, and the channel mark “052” are arranged in the descending order of the sizes thereof.

In order to avoid complication of the figure, only the channel numbers are displayed and the logos of the broadcast stations are omitted for the channel marks “0681”, “0671” and “0521” in FIG. 3. Both the channel numbers and the logos of the broadcast stations are omitted for the other channel marks represented by rectangles. In addition, the frames surrounding the channel marks other than the channel mark that is in focus are omitted in order to avoid the complication of the figure.

The ring display 101 revolves such that the multiple channel marks are moved in a direction along the closed curve 131 by a revolving operation by the user with the cross key 3A (FIG. 1).

For example, when the user operates the cross key 3A leftward, each of the multiple channel marks composing the ring display 101 in FIG. 3 is moved to the right direction opposite to the left direction in which the cross key 3A is operated by the distance corresponding to one channel. As a result, the channel mark that is in focus is moved from the channel mark “069” to the channel mark “068”.

Since the marker 132 indicates the position between the first channel mark and the last channel mark, as described above, the marker 132 is added between the first channel mark and the last channel mark on the ring display 101. Accordingly, the movement of the multiple channel marks also moves the marker 132 indicating the position between the first channel mark and the last channel mark.

For example, when the user presses the selection button 3D (FIG. 1), the channel mark that is in focus is selected and the program broadcast on the channel corresponding to the channel number of the channel mark is displayed in the display 43, for example, as the background of the ring display 101.

FIG. 4 shows an example of a screen that is displayed in the display 43 and that includes the ring display 101 to which favorite marks are added.

In the ring display 101 displayed in the screen in FIG. 4, the favorite marks 141 each having a light bulb shape are added to the channel mark “069” that is in focus and four channel marks different from the channel mark “069”.

The logo “LOGO” of the broadcast station for the channel mark “069” and the channel numbers of the channel marks “052”, “067”, and “068”, which are shown in FIG. 3, are omitted in FIG. 4 in order to avoid complication of the figure.

Each light-bulb-shaped favorite mark 141 shown in FIG. 4 is added to the channel mark by, for example, the specification operation by the user with the favorite button 3B (FIG. 1).

Specifically, when the user presses the favorite button 3B with the channel mark “069” in focus as in the screen shown in FIG. 3, the channel mark “069” is changed to the channel mark “069” to which the light-bulb-shaped favorite mark is added, as in the screen shown in FIG. 4.

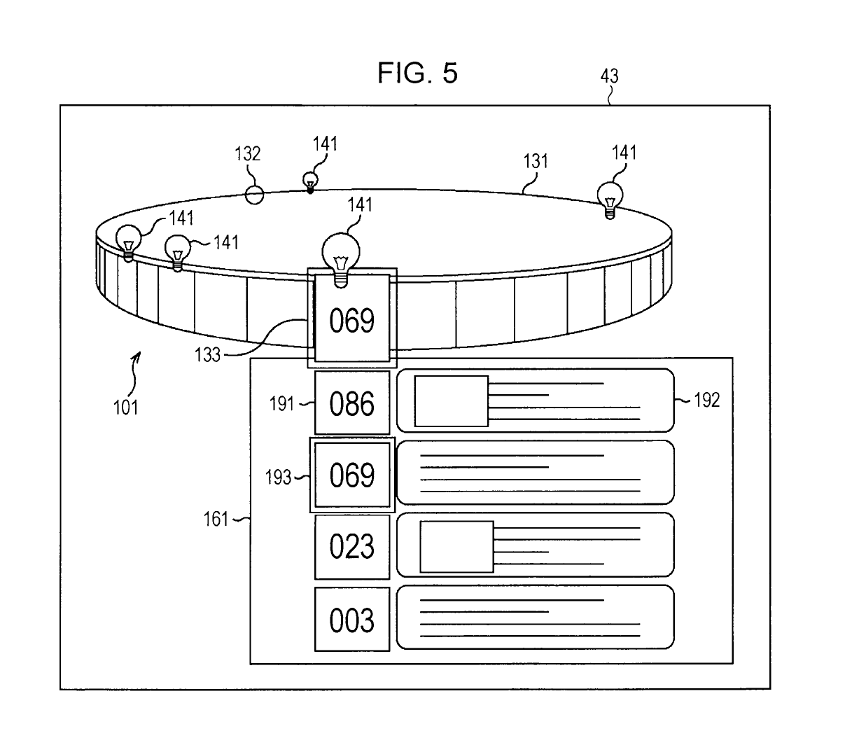

In addition to the ring display 101 to which the favorite marks are added, the channel display list may be displayed in the screen of the display 43, as shown in FIG. 5. The channel display list is a list of the channel marks specified by the specification operations by the user and the detailed information about the channels corresponding to the channel marks.

FIG. 5 shows an example of a screen that is displayed in the display 43 and that includes the channel display list displayed below the ring display 101.

Referring to FIG. 5, a channel display list 161 includes channel display rows that are vertically arranged. Each channel display row includes a channel mark 191 specified as a favorite channel by the specification operation by the user and detailed information 192 about the channel corresponding to the channel mark 191. The channel mark 191 and the detailed information 192 are horizontally arranged in the channel display row.

Specifically, the light-bulb-shaped favorite marks 141 are added to the four channel marks “086”, “069”, “023” and “003”, among the multiple channel marks, by the specification operations by the user in the ring display 101 shown in FIG. 5. Accordingly, the channel display rows including the four channel marks “086”, “069”, “023” and “003”, specified by the specification operations by the user and the detailed information about the channels corresponding to the respective channel marks are vertically arranged in the channel display list 161 in FIG. 5.

For example, detailed information about the program that is being broadcast on the channel corresponding to the channel mark 191 at the current time, for example, when the user operates the ring display button 3C to display the ring display 101 and the channel display list 161 and detailed information about the programs to be broadcast on the channel corresponding to the channel mark 191 are displayed as the detailed information 192 corresponding to the channel mark 191.

In the display screen shown in FIG. 5, the frame 133 surrounding the channel mark “069” that is in focus in the ring display 101 is highlighted. In addition, a frame 193 surrounding the channel mark “069” in the channel display list 161, corresponding to the channel mark that is in focus in the ring display 101, is highlighted by a color and/or size different from those of the frames surrounding the other channel marks “086”, “023”, and “003” in the channel display list 161, as in the channel mark “069” in the ring display 101.

The user can operate the cross key 3A downward or upward to focus on a certain channel mark in the channel display list 161 and can press the selection button 3D to select a certain channel mark in the channel display list 161, instead of selecting a channel mark in the ring display 101. In this case, the program broadcast on the channel corresponding to the certain channel mark in the channel display list 161 is displayed in the display 43, for example, as the background of the ring display 101 and the channel display list 161.

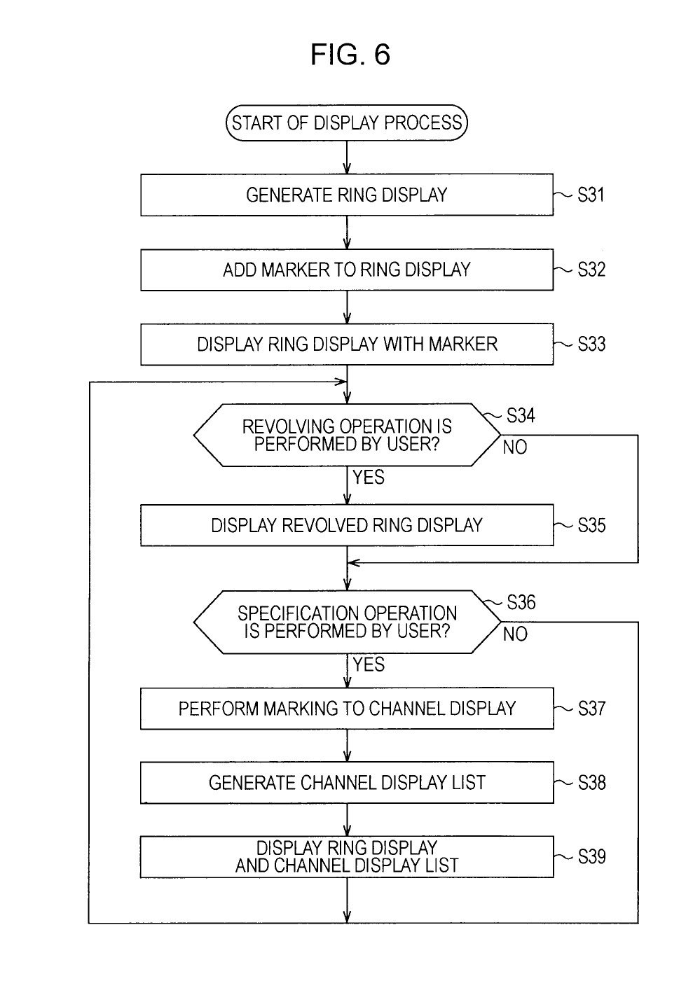

FIG. 6 is a flowchart showing an example of an operation to display the ring display 101 (hereinafter referred to as a display process) according to an embodiment of the present invention.

The display process is started, for example, when the user operates the ring display button 3C on the remote controller 3 to display the ring display 101.

In Step S31, the ring display generator 71 generates the ring display 101 on the basis of the channel numbers and the logos of the broadcast stations included in the EPG data stored in the memory 32 and supplies the ring display 101 to the marker adder 72. The ring display 101 is formed by annularly arranging multiple channel marks on which the channel numbers and the logos of the broadcast stations are displayed in a predetermined order, for example, in an order recommended by ARIB.

The ring display 101 that is generated in advance and is stored in the storage unit 31 or the memory 32 may be appropriately supplied to the marker adder 72.

In Step S32, the marker adder 72 adds the marker 132 (FIG. 3) indicating a predetermined position in the ring display to the ring display supplied from the ring display generator 71 and supplies the ring display to which the marker is added to the favorite mark adder 73.

If the favorite mark has been added to the channel mark by the specification operation by the user in the previous display process, it is possible to add the favorite mark specified by the specification operation by the user in the previous display process in the current display process described with reference to FIG. 6. However, it is assumed that the addition of the favorite mark by the specification operation by the user in the previous display process is not performed in the current display process for simplicity.

Accordingly, the favorite mark adder 73 directly supplies the ring display 101 supplied from the marker adder 72 to the OSD addition circuit 41.

In Step S33, the display controller 75 controls the OSD addition circuit 41, the image processing circuit 42, etc. to display the ring display 101 supplied from the favorite mark adder 73 to the OSD addition circuit 41 in the display 43. At this time, for example, the screen shown in FIG. 3 is displayed in the display 43.

In Step S34, the display controller 75 determines whether the revolving operation by the user with the cross key 3A (FIG. 1) is performed.

If the display controller 75 determines that the revolving operation by the user is performed, then in Step S35, the display controller 75 controls the OSD addition circuit 41, the image processing circuit 42, etc. to display the ring display 101 revolved by the revolving operation by the user in the display 43.

If the display controller 75 determines in Step S34 that the revolving operation by the user is not performed, the process skips Step S35. In Step S36, the display controller 75 determines whether the specification operation by the user with the favorite button 3B is performed.

If the display controller 75 determines that the specification operation by the user is not performed, the process goes back to Step S34 to repeat the above steps.

If the display controller 75 determines in Step S36 that the specification operation by the user is performed, then in Step S37, the favorite mark adder 73 performs the marking to the channel marks specified by the specification operations by the user, among the multiple channel marks forming the ring display 101 displayed in the display 43, and supplies the ring display 101 (FIG. 5) resulting from the marking to the OSD addition circuit 41.

In Step S38, the channel display list generator 74 generates the channel display list 161 (FIG. 5) on the basis of the channel numbers, the logos of the broadcast stations, and the detailed information about the programs included in the EPG data stored in the memory 32 and supplies the generated channel display list 161 to the OSD addition circuit 41. The channel display list 161 is a list of the channel marks specified by the specification operations by the user (the channel marks subjected to the marking in the ring display 101) and the detailed information about the channels corresponding to the channel marks.

In Step S39, the display controller 75 controls the OSD addition circuit 41, the image processing circuit 42, etc. to display the ring display 101 and the channel display list 161 supplied to the OSD addition circuit 41 in the display 43, that is, to display the ring display 101 resulting from the marking in Step S37 and the channel display list 161 generated in Step S38 in the display 43. For example, the display screen in FIG. 5 is displayed in the display 43.

Then, the process goes back to Step S34 to repeat the above steps. The display process terminates, for example, when the user operates the ring display button 3C on the remote controller 3 to cancel the display of the ring display 101.

As described above, the ring display 101 to which the marker 132 is added is displayed in the display process. Accordingly, it is possible for the user to intuitively determine what number channel mark the channel mark that is in focus or the channel mark to which the favorite mark is added is in the multiple channel marks arranged in a predetermined order on the basis of, for example, the positional relationship between the channel mark that is in focus or the channel mark to which the favorite mark is added and the marker 132.

Consequently, for example, when the multiple channel marks are arranged in the order of the genres of the programs, the user can intuitively determine the genre of the program broadcast on the channel corresponding to the channel mark that is in focus or the channel mark to which the favorite mark is added. As a result, the user can efficiently and easily select a program of a desired genre.

In addition, the favorite mark is added to the channel mark of a favorite channel or an interested channel, among the multiple channel marks in the ring display 101, in the display process.

Accordingly, for example, when the user finally selects a program to be viewed while operating the ring display 101 to perform zapping in which multiple programs are switched at short intervals, the user can add the favorite marks to the channel marks of channels which are attractive to the user or in which the user is interested in the zapping to narrow the list of the candidates for the channel mark of the program to be finally selected from the multiple channel marks. Consequently, the user can efficiently and easily select a program which the user wants to view.

Furthermore, since the detailed information about the programs is displayed in the channel display list 161 in FIG. 5 in the display process, the user can use the detailed information about the programs as determination criteria to select a program which the user wants to view. Accordingly, the user can more efficiently and easily select a program which the user wants to view.

Since the multiple channel marks are displayed as the disc-shaped ring display 101 so as to be fit into the display screen, it is possible for the user to intuitively recognize, for example, the number of the channel marks, compared with a case where the EPG is displayed in a matrix form. As a result, the user can easily recognize the overall vision of the channels.

Although the marker 132 is displayed such that the marker 132 is in contact with the ring display 101 including the multiple channel marks in the above embodiments, the marker 132 may be added in any manner as long as the marker 132 indicates, for example, the position between the first channel mark and the last channel mark. For example, an arrow that indicates the position between the first channel mark and the last channel mark and that is displayed so as not to be in contact with the ring display 101 may be adopted as the marker 132 to be added to the ring display 101.

Although the ring display 101 (FIG. 3 or 5) is displayed in which some channel marks among the multiple channel marks are horizontally arranged in a band shape in the above embodiments, the ring display 101 may be displayed in any manner as long as the marker 132, the light-bulb-shaped favorite marks 141, and the channel mark that is in focus are not hidden and the multiple channel marks are annularly arranged. For example, some channel marks among the multiple annually-arranged channel marks may be vertically arranged in a band shape in the ring display or all the multiple channel marks may be displayed in the ring display.

Although the channel display rows are vertically arranged in the channel display list 161 in FIG. 5, the channel display rows may be horizontally arranged.

Although the channel marks and the detailed information about the channels corresponding to the channel marks are displayed as the channel display rows in the channel display list 161 in FIG. 5, for example, only the channel marks may be displayed without displaying the detailed information about the channels corresponding to the channel marks.

Although the channel numbers and the logos of the broadcast stations are displayed in the channel marks in the above embodiments, only either of the channel numbers and the logos of the broadcast stations may be displayed.

Although the multiple channels are exemplified as the choices for the user in the above embodiments, the choices for the user may be content items including motion pictures, music tunes, still images, and animated films, instead of the channels.

The embodiments of the present invention are applicable to a personal computer, a personal digital assistant (PDA), or a mobile phone that displays content items on its display screens, in addition to the DTV.

The steps describing the processes may not necessarily be executed in time series in the order described in the flowcharts and may be executed in parallel or individually.

It should be understood by those skilled in the art that various modifications, combinations, sub-combinations and alterations may occur depending on design requirements and other factors insofar as they are within the scope of the appended claims or the equivalents thereof.

What is claimed is:

1. A display control apparatus controlling display of a graphical user interface including a plurality of choices which are presented to a user and from which the user selects a choice, the apparatus comprising:
ring display generating means for generating a ring display serving as the GUI, the ring display being formed by annually arranging a plurality of marks corresponding to the choices in a predetermined order;
marker adding means for adding a marker indicating at least one of the position of the first mark and the position of the last mark, among the plurality of marks arranged in the predetermined order, to the ring display; and
display controlling means for displaying the ring display to which the marker is added.

2. The display control apparatus according to claim 1, further comprising:
marking means for adding a mark specified by a specification operation by the user in the plurality of marks forming the ring display.

3. The display control apparatus according to claim 2, further comprising:
mark list generating means for generating a mark list that is a list of the marks added by the marking means,
wherein the display controlling means displays the mark list generated by the mark list generating means.

4. The display control apparatus according to claim 3, wherein the mark list generating means generates the mark list including detailed information about the choices corresponding to the marks added by the marking means.

5. The display control apparatus according to claim 1, wherein the display controlling means highlights a mark that is in focus in the plurality of marks forming the ring display.

6. A display control method for a display control apparatus controlling display of a graphical user interface including a plurality of choices which are presented to a user and from which the user selects a choice, the method comprising:
generating a ring display serving as the GUI, the ring display being formed by annually arranging a plurality of marks corresponding to the choices in a predetermined order;
adding a marker indicating at least one of the position of the first mark and the position of the last mark, among the plurality of marks arranged in the predetermined order, to the ring display; and
displaying the ring display to which the marker is added.

7. A computer-readable program for a display control apparatus controlling display of a graphical user interface including a plurality of choices which are presented to a user and from which the user selects a choice, the program comprising:
generating a ring display serving as the GUI, the ring display being formed by annually arranging a plurality of marks corresponding to the choices in a predetermined order;
adding a marker indicating at least one of the position of the first mark and the position of the last mark, among the plurality of marks arranged in the predetermined order, to the ring display; and
displaying the ring display to which the marker is added.

8. A display control apparatus controlling display of a graphical user interface including a plurality of choices which are presented to a user and from which the user selects a choice, the apparatus comprising:
a ring display generating unit configured to generate a ring display serving as the GUI, the ring display being formed by annually arranging a plurality of marks corresponding to the choices in a predetermined order;
a marker adding unit configured to add a marker indicating at least one of the position of the first mark and the position of the last mark, among the plurality of marks arranged in the predetermined order, to the ring display; and
a display controlling unit configured to display the ring display to which the marker is added.
